(19) United States
(12) Patent Application Publication
(10) Pub. No.: US 2003/0115318 A1
(43) Pub. Date: Jun. 19, 2003

(54) Concentric user-targeting delivery system and methods

(75) Inventor: Kevin Michael Wueste, Seattle, WA (US)

Correspondence Address: Steven J. Rocci, Woodcock Washburn Kurtz, Mackiewicz & Norris LLP, One Liberty Place-46th Floor, Philadelphia, PA, 19103, US

(73) Assignee: Microsoft Corporation.

(21) Appl. No.: 10/023,285

(22) Filed: Dec. 13, 2001

(51) Int. Cl. G06F 15/16

(52) U.S. Cl. 709/224; 709/246

(57) ABSTRACT

A system and methods to generate and deliver concentric-user targeted content is provided. The concentric user-targeted content delivery system cooperates with a user profile data store and users' usage behavior data store to generate a baseline of users' preferences. Using the preference information a range of relevant content, obtained from a cooperating content data store, is matched for a particular user using at least one matching algorithm. The range of relevant content reflects a comprehensive description of a user's preference in totem. In operation, user profile information along with a user's usage behavior information is processed to generated a user's preference information. The preference information is processed to aggregate a range of relevant content from a cooperating data store. In an illustrative implementation, the range comprises micro, mezzo, and macro-related content that are related in various degrees to the user's profile and/or usage behavior information.

### FIELD OF THE INVENTION

The present invention relates to interactive content offered in computing environments. More particularly, to systems and methods that allow for the creation and distribution of concentric-user targeted content.

### BACKGROUND OF THE INVENTION

The delivery of relevant online content is a challenge facing today's content service providers. As more customers integrate online content in their daily practice, content service providers are constantly developing and offering new services and features to distinguish themselves from each other in an effort to attract and/or retain customers. A common practice employed by content providers is known as psycho-graphic profiling. Psycho-graphic profiling is a process where user behavior of content is monitored to establish a baseline of user preferences. Using the preference information, content providers aggregate similar content to offer to the monitored users. The result, as hoped by content providers, is that users are offered additional relevant content that enhances their overall user experience. In addition, content providers can categorize their customer base according to determined preferences rendering easier the tasks of targeting their own and content partner products and services. Profiling has been most effective in the search and e-commerce realms of the online content universe.

For example, a participating user may navigate to a content service provider offering search features. The participating user may input a search on the Philadelphia Seventy Sixers (76ers) in an effort to learn more about a recent player trade. The content service provider using psycho-graphic profiling could monitor the participating user's content usage behavior to determine that this user has a preference for the 76ers NBA® franchise. Using this preference information, the content service provider can aggregate additional content (e.g. 76er's merchandise offerings; news stories about the 76ers, etc.) and offer the additional content to the participating user. The additional content can be offered in a variety of manners including but not limited to generating additional content display panes in the user's computing environment and incorporating additional links in the originally requested content. Accordingly, profiling allows content service providers that ability to offer additional relevant content to participating users. Moreover it is an effective tool in helping to target products and services for content partners.

In the e-commerce context, electronic shopping systems currently exist which allow users to remotely purchase goods and services from a variety of different on-line merchants over a distributed computer network such as the Internet. With systems of this type, the on-line merchants typically publish on-line catalogs that can be viewed interactively by the end users of the network using a personal computer. These catalogs include pictures, textual descriptions, and pricing information with respect to the products and/or services of the respective merchants, and typically include on-line forms for allowing users to return purchase orders to the merchants over the network. In World Wide Web (“Web”) based implementations, the on-line catalogs are in the form of hypertext documents which are hosted by the Web sites of the respective merchants, and the catalogs are accessed using a standard Web browser application which runs on the user computer. (A Web site is an Internet-connected computer or computer system that runs server software for serving information using the standard protocols of the World Wide Web.) In other implementations, the on-line catalogs may, for example, be hosted by a centralized computer of an on-line services network, such as MSN®, or by an Internet site which is accessed using a proprietary client application.

However, most often e-consumers do not receive information that truly matters to them during their e-shopping experience. Current online content is generally categorized in “content verticals”—or more accurately, is aligned around a single, or a set of specific subject matter areas. Using the example above, content service providers using current profiling practices may only offer basketball related content in response to the user's 76ers search. Such practice has significant drawbacks as the user experience becomes too focused not availing or accounting for the user's preferences in totem. Furthermore, profiling is only employed by a number of content service providers thereby rendering most online marketing efforts as completely random. The randomness in marketing content degrades typical user experiences as participating users are constantly charged with the task of avoiding irrelevant and unwanted content. Furthermore, with random marketing efforts, content partners, in essence, are broadcasting marketing messages to blind eyes and deaf ears. A more advantageous content delivery system would learn from participating users' content usage and correlate more comprehensive content offered as concentric targeted content.

Therefore it is appreciated that there exists a need for a system and methods that deliver concentric user-targeted content that overcome the prior art.

### SUMMARY OF THE INVENTION

A system and methods to deliver concentric user-targeted content is provided. In an illustrative implementation, the concentric user-targeted content delivery system comprises a user profile data store, user content usage data store, and an affinity/preference algorithm. In operation, the concentric user-targeted delivery system cooperates with a user profile data store and user usage data store to obtain data indicative of a user's current content usage and a user's profile (e.g. demographic information, preference information, etc.). The usage and profile data are processed by the concentric user-targeted content delivery system to establish a baseline of user preferences. Using the preference information, the concentric user-targeted delivery system executes at least one matching algorithm to aggregate from at least one content data store a range of additional content offerings that directly correlate to the user profile and usage behavior. The additional content offerings range is categorized into micro, mezzo, and macro-related content offerings.

In addition to the just described benefits, other advantages of the present invention will become apparent from the detailed description which follows hereinafter when taken in conjunction with the accompanying drawing figures.

### BRIEF DESCRIPTION OF THE DRAWINGS

The system and methods for the system and methods delivering concentric user-targeted content are further described with reference to the accompanying drawings in which:

FIG. 1 is a block diagram representing an exemplary computing environment in which the present invention may be implemented;

FIG. 2 is a block diagram representing an exemplary computing network environment in which the present invention may be implemented;

FIG. 3 is a block diagram showing the interaction of components of a concentric user-targeted content delivery system in accordance with the present invention;

FIG. 4 is a block diagram of cooperating components that provide data and operations for the concentric user-targeted content delivery system in accordance with the present invention;

FIG. 5 is a topographical diagram of the content offerings of the concentric user-targeted content delivery system;

FIG. 6 is a screen shot of an exemplary computing application offering concentric user-targeted content delivery features in accordance with the present invention; and

FIG. 7 is a data flow diagram of the data employed by the concentric user-targeted content delivery system; and

FIG. 8 is a flowchart diagram showing the processing performed to deliver concentric user-targeted content in accordance with the present invention.

### DETAILED DESCRIPTION OF PREFERRED EMBODIMENTS

Overview

Today, online content delivery systems have proven to be an extremely effective communication medium. Given this reality, it is not surprising that there is a sharp increase in the number of online content service providers, rendering content delivery a very competitive space. Generally, content service providers have varied offerings that include a wide range of products and services. Novelty, quality, and reliability tend to be distinguishing characteristics that separate competing content providers.

In the content delivery market space, a key service offers users additional relevant targeted content over and above originally requested content. Such practice benefits users and content service providers alike. Participating users are offered a more relevant user experience and content service providers are afforded an effective tool in targeting content for content partners. A common practice employed by content service providers is psychographic profiling. This practice requires content service providers to monitor user content usage to establish a baseline of preferences. These preferences are subsequently used to aggregate additional similar content that is offered to these monitored users. Using profiling, users are offered additional relevant content and content service providers are given an effective tool to target content for themselves and for their content partners.

However, current practices are lacking as they tend to offer content relating to a single or, alternatively, a set of specific subject matter areas, disregarding and not accounting for a user's total preferences. Moreover, some content providers do not employ profiling practices rendering the offering additional content (usually marketing content) a random exercise. The present invention aims to ameliorate the shortcomings of current practices by offering a system and methods that deliver concentric user-targeted content. Stated differently, using a user's profile information and content usage behavior, the present invention offers more comprehensive additional relevant content. This comprehensive additional content is aggregated using at least one matching algorithm that generates a range (e.g. micro, mezzo, and macro-related content) offerings that better describe the user's preferences in totem. By providing all at once a narrow, medium-wide and wide view of the audience, the present invention can deliver content to satisfy a number of content partners (e.g. advertisers) simultaneously while providing useful and relevant additional content to enhance the user's experience. In an illustrative implementation, the concentric user-targeted content may be delivered to participating users in a computing environment through a browser computing application, or any other user agent that share information about participating users with a content data store that supports targeted content.

Exemplary Operating Environment

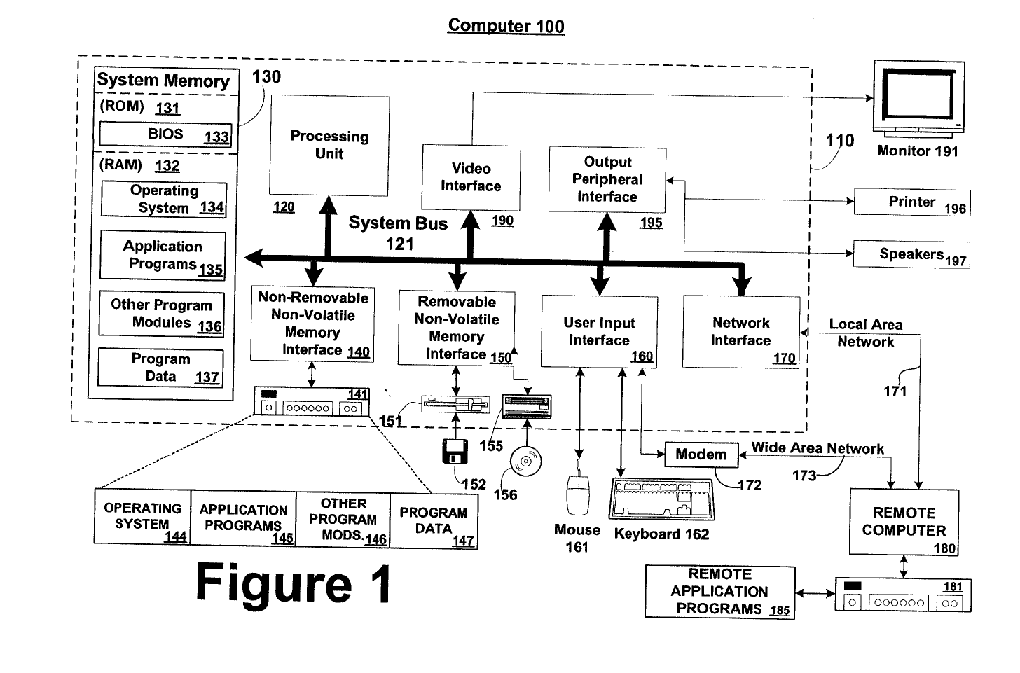

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during startup, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Network Environments

One of ordinary skill in the art can appreciate that a computer 100 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having access to appropriate classification data.

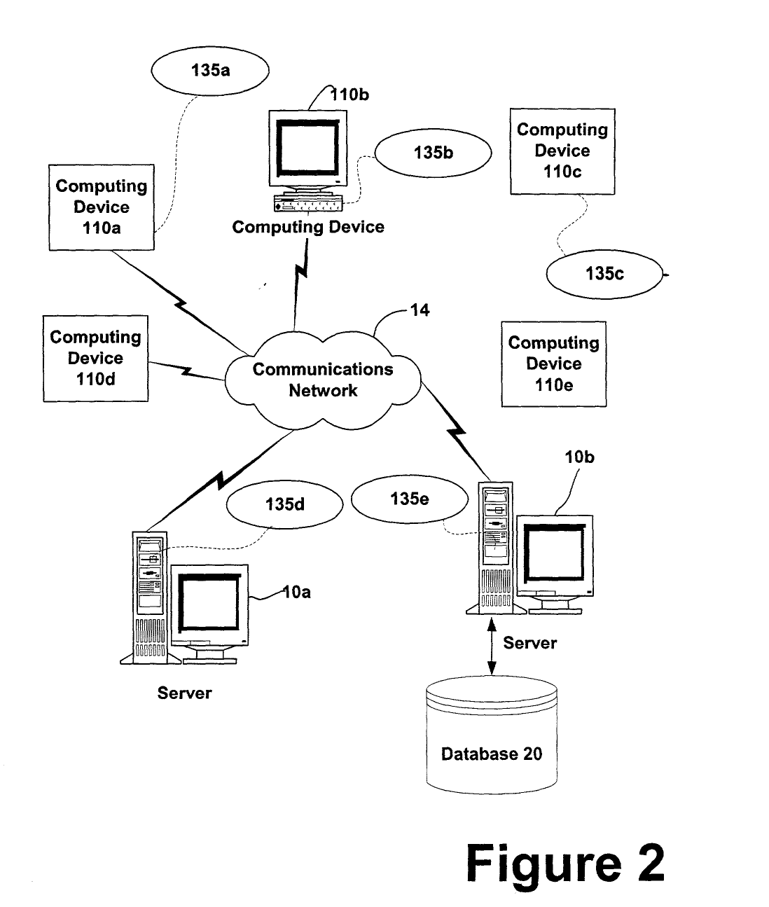

FIG. 2 illustrates an exemplary network environment, with a server in communication with client computers via a network, in which the present invention may be employed. As shown, a number of servers 10a, 10b, etc., are interconnected via a communications network 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, such as a VCR, TV, and the like in accordance with the present invention. It is thus contemplated that the present invention may apply to any computing device in connection with which it is desirable to provide classification services for different types of content such as music, video, other audio, etc. In a network environment in which the communications network 14 is the Internet, for example, the servers 10 can be Web servers with which the clients 110a, 110b, 110c, 110d, 110e, etc. communicate via any of a number of known protocols such as hypertext transfer protocol (HTTP). Communications may be wired or wireless, where appropriate. Client devices 110 may or may not communicate via communications network 14, and may have independent communications associated therewith. For example, in the case of a TV or VCR, there may or may not be a networked aspect to the control thereof. Each client computer 110 and server computer 10 may be equipped with various application program modules 135 and with connections or access to various types of storage elements or objects, across which files may be stored or to which portion(s) of files may be downloaded or migrated. Any server 10a, 10b, etc. may be responsible for the maintenance and updating of a database 20 in accordance with the present invention, such as a database 20 for storing classification information, music and/or software incident thereto. Thus, the present invention can be utilized in a computer network environment having client computers 110a, 110b, etc. for accessing and interacting with a communications network 14 and server computers 10a, 10b, etc. for interacting with client computers 110a, 110b, etc. and other devices 111 and databases 20. Communications network comprises any of a wireless LAN, a fixed wire LAN, a wireless WAN, a fixed wire WAN, a wireless intranet, a fixed wire intranet, a wireless extranet, a fixed wire extranet, a wireless peer-to-peer communications network, a fixed wire peer-to-peer communications network, the wireless Internet, and the Internet.

Concentric-User Targeted Content Delivery

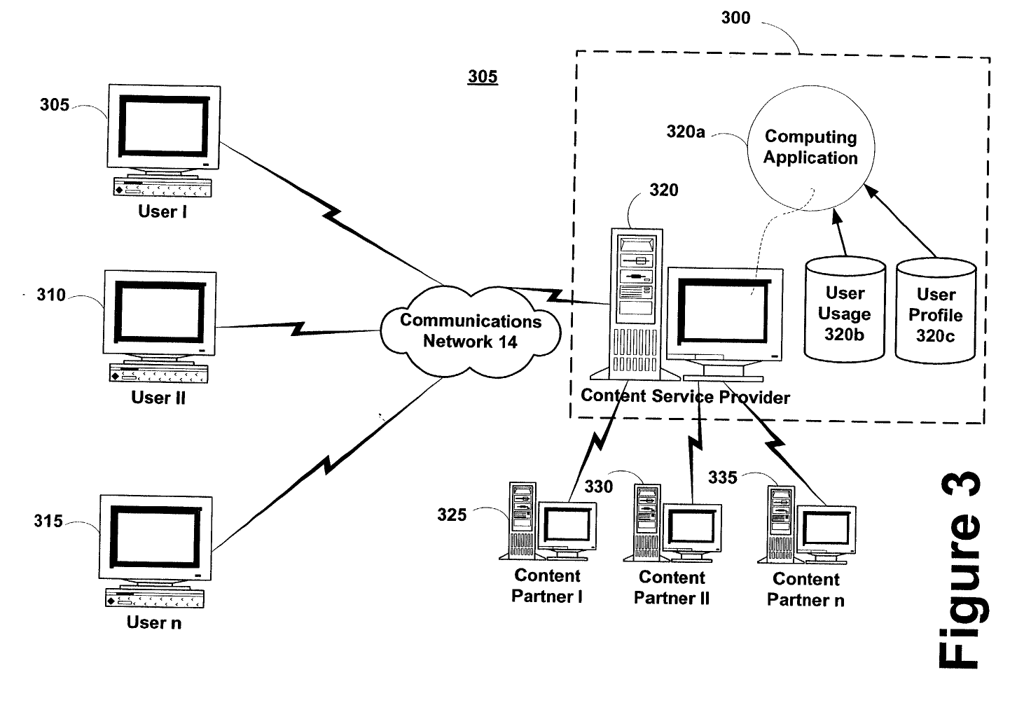

FIG. 3 shows a block diagram of an exemplary concentric user-targeted content delivery system. As shown, concentric user targeted content delivery system 300 operates in an exemplary network computing environment 305. The concentric user targeted content delivery system 300 comprises computing application 320a operating on content service provider server 320 cooperating with user usage data store 320b and user profile data store 320c. In operation participating users I through n, communicate with content service provider 320 to register profiles on user profile data store 320c through computing application 320a. The user profiles contain user demographic and possible preference information (e.g. home owner, car owner, likes stand-up comedy, etc.). A participating user can request content from content service provider 320 by inputting a content request on an interface (not shown) (e.g. content browser computing application—Web browser) offered client computing devices 305, 310, and 315. The content request in turn is communicated to content service provider 320 over communications network 14. The content service provider 320 processes the content request and aggregates and/or generates content to fulfill the original content. In addition, content service provider 320 executes concentric user-targeted content delivery system 300 to create additional relevant content for delivery with the originally requested content. The concentric user-targeted content delivery system cooperates executes one or more sets of instructions as defined by computing application 320a. Computing application 320a cooperates with user usage data store 320b and user profile data store 320c to generate a baseline of user preferences. Using these preferences a range of concentric user-targeted content is aggregated and/or generated for delivery to the participating user. As part of concentric user-targeted content aggregation and/or generation, concentric user-targeted content delivery system 300 may cooperate with one or more content partners 325, 330, and 335 to obtain ascertained concentric user-targeted content. These content partners may comprise advertisers and/or marketers that are trying to reach a target audience to offer a specific product and/or service. The original and concentric user-targeted content is then communicated by content service provider 320 to client computing devices 305, 310, and 315 for display on client computing device interfaces (not shown—e.g. content browser computing application—Web browser) over communications network 14.

In an illustrative implementation, the present invention may be described from two perspectives, that of participating users and the content service provider (or content partner—advertiser/marketer). From participating user's perspective, participating users are generally interested in receiving information that is relevant to them. They are also interested in keeping personal information private (e.g., Race, Gender, Age, Address, Income, etc.). The concentric user-targeted content delivery system of the present invention maintains a central repository of personal information that is learned by user behavior (click streams) and system registrations (e.g., MICROSOFT® Passport and the Universal Profile Store (UPS)). By combing these two data streams, concentric user-targeted content delivery system 300 provides participating users with additional relevant content.

From the content provider's perspective, content providers are constantly looking for new and better ways to communicate with specific audience groups (e.g. web-rings and overlapping consumer target groups based on key data). The concentric user-targeted content delivery system 300 enables content providers and content partners to address simultaneously a very wide audience through the less correlated concentric user-targeted content and to a narrow group that they are targeting for a specific offer through more correlated concentric user-targeted content. Generally, content providers and content partners benefit as participating users are specifically targeted that may represent ideal demographics. This type of selective targeting and wide broadcast may translate to more content usage that in turn may result in increased revenues.

In the illustrative implementation, concentric user-targeted content delivery system 300 may be realized as a “middle-ware” tool that presents more valuable and specific set of content provider and participating user information. In this exemplary implementation, concentric user-targeted content may be presented in the form of 3 embedded display panes in a content browsing computing application that are embedded. The display panes represent three graduated levels of user targeting. These display panes maintain an amount of intelligence in that they track and respond to a participating user through his/her content usage session. In this implementation, the three display panes comprise a macro (the least targeted) pane (e.g. this macro display pane may be populated with content based on based on CZAG+rudimentary knowledge of online behavior—shops online), a mezzo display pane (e.g. the mezzo display pane may encompass but does not overlap the content offerings offered in the macro display pane). The mezzo display pane operation extends the macro processing by using additional participating user information comprising:

First Name and Last Name

Gender

Age

Street Address and Zip Code

Neighborhood

Preference Information (that might include):

Shops online for movies and books and music

Likes Adult Rock Music

Likes Comedy Movies

Likes Cop-Drama and Hospital-Drama Television Programming

Likes Baseball, Football and Basketball

Owns Home

Travels For Fun Twice a Year or More;

The micro display pane extends the processing performed by mezzo display pane to include additional information comprising when processing micro-level concentric user-targeted content:

First Name, Last Name

Gender

Age

Street Address and Zip Code

Neighborhood

User Preferences (including but not limited to):

Shops online for movies and books and music

Likes Adult Rock Music—And recently purchased: Dave Matthews, Counting Crows, Sheryl Crow, Pearl Jam, Creed, Metallica, and Eve CDs

Likes Comedy Movies—And recently saw or rented or bought: Dumb & Dumber, Big Daddy, Something About Mary

Likes Cop-Drama and Hospital-Drama Television Programming

Likes Baseball, Football and Basketball—And goes to Bulls home games and watches them and the White Sox on TV whenever possible

Owns Home—for 5 years—did a remodel and added a bathroom as a DIY project

Travels For Fun 2×/year—Last year went to Curacao with the family and to Pebble Beach to play golf with his buddies

Reads a Book a Month—And recently purchased books by: Grisham, Ludlum and Elmore Leonard

Has a chocolate Labrador retriever.

Has bought books for his collection via E-bay

Maintains a Residential Subscription to The Following: Sports Illustrated, WSJ, Ad Week, and Better Homes

It should be understood that the above lists are merely exemplary as the present invention contemplates the use of various participating user information when processing concentric user-targeted content. In addition, it should be understood that the present invention is not limited to delivering concentric user-targeted content exclusively in three graduated display panes, rather the inventive concepts contained herein extend to the deliver of any number of concentric user-targeted content (e.g. zero to infinity).

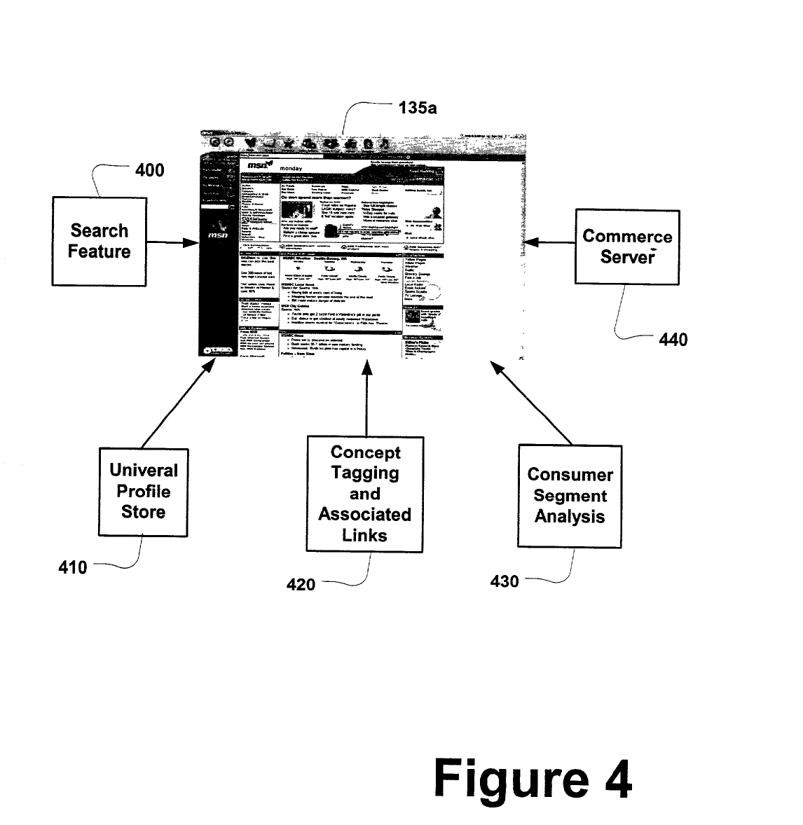

FIG. 4 shows a block diagram showing the cooperation of various data and features employed to realize concentric user-targeted content delivery. As shown, the concentric user-targeted content is displayed and made ready for interaction on exemplary computing application 135a. Exemplary computing application accepts as input search feature 400, universal profile store 410, concept tagging and associated links 420, consumer segment analysis 430, and commerce server 440. In operation, these components cooperate to provide exemplary computing application 135a with the resources to process participating user usage and profile information to deliver concentric user-targeted content. For example, the universal profile data store 410 offers exemplary computing application 135a user profile information. The search feature allows exemplary computing application 135a to gain insight into participating user's content usage. Similarly concept tagging and associated links 420 act as interfaces for users that assist exemplary computing application 135a to gain insight into participating users' usage—participating user's content usage (both current and historical) information is critical to the success of the delivery of concentric user-targeted content. Consumer analysis segment 430 provides empirical data for use by exemplary computing application 135a when ascertaining participating user content preferences. Lastly, commerce server 440 cooperates with exemplary computing application 135a to offer content from which exemplary computing application 135a may choose to deliver concentric user-targeted content.

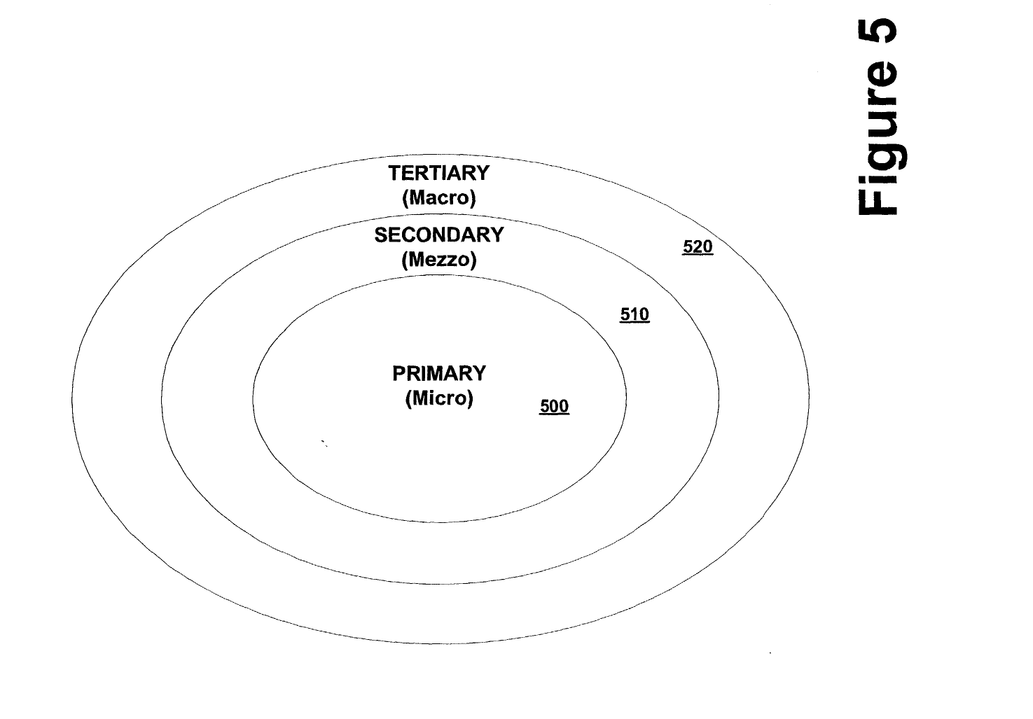

FIG. 5 is a block diagram showing the inter-relationship between the elements of a range of concentric user-targeted content offerings that are generated and delivered by the concentric user-targeted content delivery system 300 of FIG. 3. As shown in the illustrative implementation, concentric user-targeted content range 500 comprises primary (micro) concentric content offering 505, secondary (mezzo) concentric content offering 510, and a tertiary (macro) concentric content offering 520. These content offering correlate in varying pre-defined degrees to a user's usage and profile information. For example, a participating user may request original content relating to flea removal for pets. Also, the user's recent content usage history indicates that the user was requesting travel content. Employing this content usage information and processing it with the user's profile information which indicates that the user is a dog owner, a SUV owner, the concentric user-targeted content delivery system 300 of FIG. 3 may aggregate a range of additional relevant content offerings comprising a dog flea collar advertisement as the primary (micro) concentric content offering, a pet de-odorizer for vehicles as secondary (mezzo) concentric content offering, and a kennel shelter as the tertiary (macro) concentric content offering. From a marketing standpoint the primary (micro) concentric content offering represents the “buy” content offering. That is, a product that is directly related to the user's original request. The secondary (mezzo) concentric content offering represents the “product” content offering. That is, a product that is not directly related to the user's original request. However, the secondary (mezzo) concentric content offering is more correlated to the user's profile (i.e. the user is a vehicle owner). Lastly, the tertiary (macro) concentric content offering represents the “brand” content offering. The brand content offering is not directly related to the user's original request. However, the “brand” content offering is more correlated to the user's content usage (i.e. request for travel content) and profile (i.e. user is a pet owner). By offering a range of concentric user-targeted content, the user is offered additional relevant content that is more representative of the user's preferences (through content usage and profile assimilation) in totem.

It is appreciated that although the concentric user-targeted delivery system has been shown to support three levels of concentric user-targeted content, the present invention contemplates offering an infinite ranges of concentric targeting (e.g. 2 levels, 4 levels, 5 levels, etc.).

Concentric user-targeted content covers breadth and depth. For example, from an advertising or direct marketing perspective, product information, coupons, and offers to buy may be offered. In addition, concentric user-targeted content supports various genres of content such as a contextual vertical or more relevant stories that pertain to the participating user's preferences (e.g. a story about an upcoming Seattle Seahawks parade for a Seahawks fan, or a story about a fire department pancake fundraiser in a particular neighborhood, or for cinema-philes, a story about a movie premier).

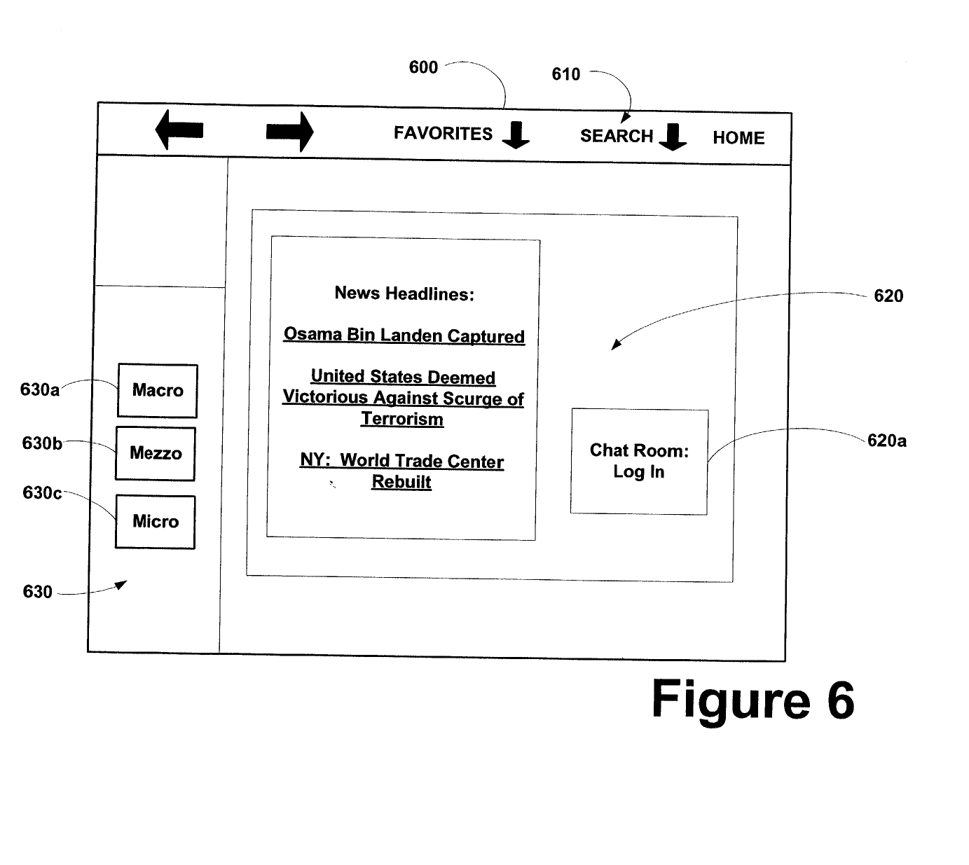

FIG. 6 is a screen shot of an exemplary computing application offering concentric user-targeted content delivery features. As shown the exemplary computing application has a display pane 600. Display pane has navigation controls 610 that when operable allow participating users (not shown) to navigate through content. In addition, display pane 600 comprises content display area 620 capable of displaying and offering for interaction content 620a. Lastly, in the illustrative screen shot, display pane 600 offers concentric user-targeted delivery display and interaction area 630. As shown, concentric user-targeted content delivery display and interaction area 630 is capable of displaying and offering for interaction concentric user-targeted content 630a, 630b, and 630c. In an illustrative implementation, the concentric user-targeted content 630a comprises micro-related content that is related in a first degree to a user's content usage and profile information. Similarly, concentric user-targeted content 630b comprises mezzo-related content that is related in a second degree to a user's content usage and profile information. Lastly, concentric user-targeted content 630b comprises macro-related content that is related in a third degree to a user's content usage and profile information. It is understood that although, the concentric user-targeted content delivery display and interaction area 630 is shown to occupy a specific region of the exemplary display pane 600 and comprises three range concentric content offering, the concentric user-targeted content delivery display and interaction area 630 can occupy varying regions within exemplary display pane 600 of the exemplary computing application and is capable of offering a various range (e.g. one to infinity) of concentric user-targeted content.

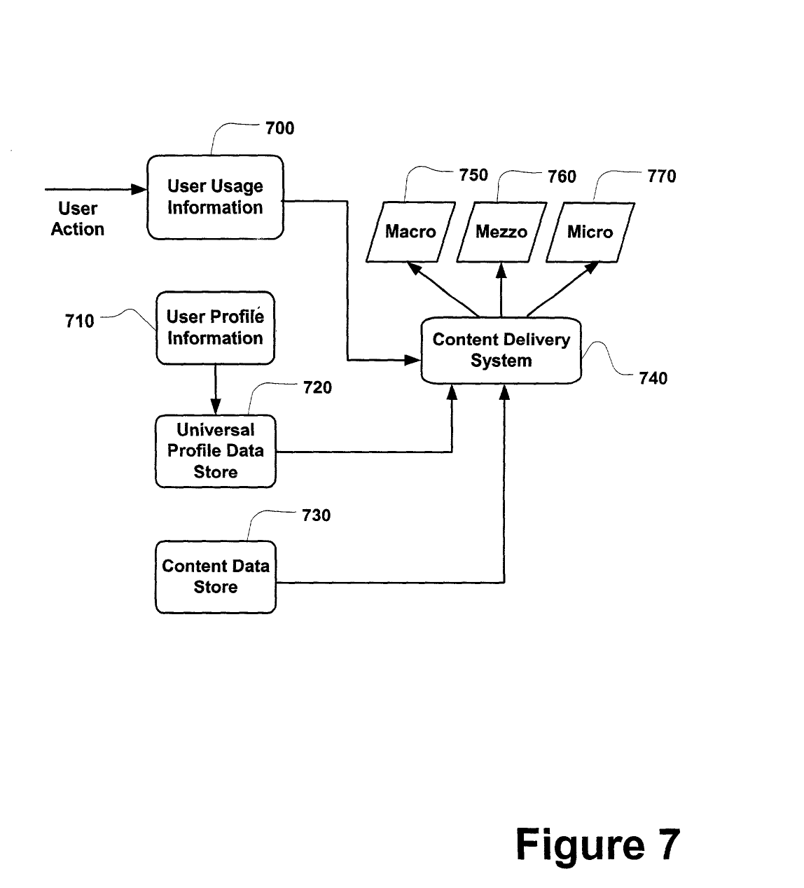

FIG. 7 is a data flow diagram of the data employed to deliver concentric user-targeted content to participating users. As shown a user action initiates the storage of the user's content usage information at block 700. In addition, user profile information is generated at block 710 and stored by universal profile store at block 720. The user usage information, universal profile store, and content data store 730 serve as input to concentric user-targeted content delivery system 740. Using these data inputs, the concentric user-targeted delivery system 740 generates a range of relevant content. In an illustrative implementation, the range of relevant content comprises micro, mezzo, and macro-related content that is related in various degrees to the user's usage and profile information.

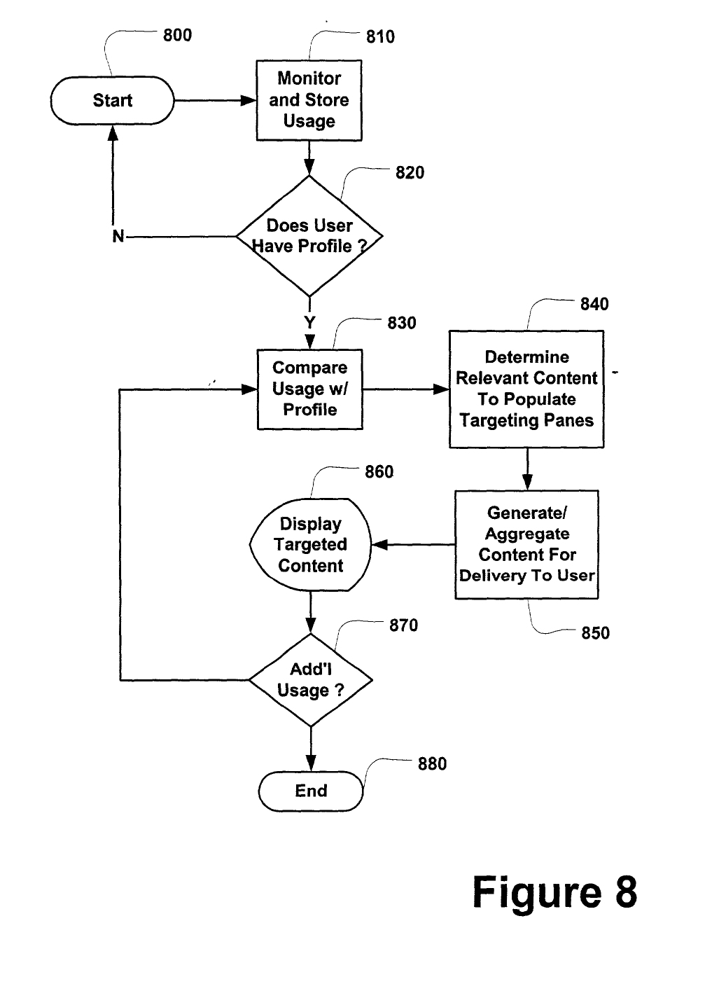

FIG. 8 is a flowchart diagram showing the processing performed to generate and deliver concentric user-targeted content to participating users. As shown, processing begins at block 800 and proceeds to block 810 where a user's usage is monitored and stored. A check is then performed at block 820 to determine if the monitored user has a profile. If the monitored user does not have a profile processing reverts back to block 800 and proceeds from there. However, if the alternative proves to be true, processing proceeds to block 830 where the usage information is compared with the profile information to obtain a baseline of user preferences. In operation, this comparison may be accomplished through the execution of one ore more matching, weighting, and/or query algorithms including but not limited to machine learning algorithms, b-tree search algorithms, average weight algorithms, and nearest neighbor algorithms. From block 830, processing proceeds to block 840 where the generated preferences of block 830 are used by at least one matching algorithm to aggregate a range of concentric relevant content. In an illustrative implementation, the range of concentric content comprises micro, mezzo, and macro-related content that is correlated in various pre-defined degrees (e.g. as determined by matching algorithm parameters) to the user usage and profile information. The aggregated content is formatted at block 850 for delivery to monitored user. The concentric user-targeted content is then displayed to the monitored user at block 860. A check is then performed to determine if there is additional user content usage at block 870. If there is no additional content usage, processing terminates at block 880. However, if the alternative proves true, processing reverts to block 830 and proceeds from there.

The various techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the indexing functionality of the present invention. For example, the storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating there from. For example, while exemplary embodiments of the invention are described in the context of music data, one skilled in the art will recognize that the present invention is not limited to the music, and that the methods of tailoring media to a user, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Therefore, the present invention should not be limited to any single embodiment, but rather construed in breadth and scope in accordance with the appended claims.

What is claimed is:

1. A system to generate and deliver concentric user-targeted content comprising:,
one or more data stores having data representative of participating user profile information and/or data representative of participating user content usage information;
a content data store, said content data store having various content for display to participating users; and
at least one set of instructions, said instruction set cooperating with said first, second, and content data stores,
wherein said instruction set operates on data from said first and second data stores to generate at least one preference for said participating user,
wherein said instruction set further operates on said generated preference to obtain a range of concentric content from said content data store such that said range of content is correlated in varying degrees to said generated at least one preference for said participating user.

2. The system as recited in claim 1, wherein said profile information is inputted by said participating user for storage on said first data store.

3. The system as recited in claim 2, wherein said profile information comprises demographic and/or preference information for said participating user.

4. The system as recited in claim 1, wherein said usage information comprises current and historical usage information.

5. The system as recited in claim 1, wherein said instruction set comprises at least one matching algorithm, said matching algorithm accepting as input said data from said first and second data stores and generating said at least one preference.

6. The system as recited in claim 5, wherein said instruction set further comprises a second matching algorithm, said second algorithm accepting said at least one preference and said content from said content data store as input to generate said range of concentric content.

7. The system as recited in claim 1, wherein said range of concentric content comprises one to infinity number of differing content offerings.

8. The system as recited in claim 7, wherein said differing content offerings differ from each other on a graduated basis.

9. The system as recited in claim 8, wherein said varying degrees are based on said content usage information.

10. The system as recited in claim 1, wherein said range of concentric content comprises three differing concentric content offerings, said differing concentric content offerings differing from each other on a graduated basis.

11. The system as recited in claim 1, wherein said first, second, and content data stores operate in a computing environment.

12. The system as recited in claim 11, wherein said instruction set comprises a computing application.

13. The system as recited in claim 12, wherein said range of concentric content is delivered to participating users over a communications network.

14. The system as recited in claim 13, wherein said communications network comprises any of a wireless LAN, a fixed wire LAN, a wireless WAN, a fixed wire WAN, a wireless intranet, a fixed wire intranet, a wireless extranet, a fixed wire extranet, a wireless peer-to-peer communications network, a fixed wire peer-to-peer communications network, the wireless Internet, and the Internet.

15. The system as recited in claim 13, wherein said range of concentric content is displayable in electronic display panes.

16. The system as recited in claim 15, wherein said electronic display panes are part of a content browser computing application.

17. A computer implemented method to generate concentric user-targeted content comprising the steps of:
receiving from one or more data stores having data indicative of participating user profile information and/or data indicative of participating user content usage information;
receiving content from at least one content data store;
generating at least one preference for said participating user; and
matching said at least one preference with said content from data store to generate said range of concentric user-targeted content.

18. The method as recited in claim 17 further comprising the step of:
distributing said range of differing concentric content to said participating users over a cooperating communications network.

19. The method as recited in claim 17, wherein said generating step comprises the step of:
applying at least one matching algorithm to said at least one preference and said content.

20. The method as recited in claim 17, further comprising the step of:
communicating with at least one content partner to obtain additional content for use when generating said range of concentric content.

21. A computer readable medium having computer readable instructions to perform the method as recited in claim 17.

22. A method to generate and deliver concentric user-targeted content comprising the acts of:
providing one or more data stores having data indicative of participating user profile information and/or data indicative of participating user content usage information;
providing a content data store, said content data store having content from at least one content service provider; and
providing a computing application, said computing application cooperating with said first, second, and content data stores to generate preferences from said profile and said content usage information, wherein said computing application processes said preferences along with said content to ascertain a range of concentric user-targeted content, said range of concentric content differing from each other on a graduated basis; and
delivering said generated range of concentric user-targeted content to participating users over a communications network, said communications network cooperating with said computing application.

23. The method as recited in claim 22, wherein said providing said content data store step further comprises cooperating with at least one content partner to obtain said content.
